(19) United States
(12) Patent Application Publication
(10) Pub. No.: US 2011/0103587 A1
(43) Pub. Date: May 5, 2011

(54) DATA CONCEALING APPARATUS, DATA DECRYPTION APPARATUS AND IMAGE FORMING APPARATUS HAVING DATA ENCRYPTING FUNCTION

(75) Inventors: Akihiko ODA, Tokyo (JP); Yasuaki Sugimoto, Tokyo (JP)

(73) Assignee: KONICA MINOLTA BUSINESS TECHNOLOGIES, INC., Tokyo (JP)

(21) Appl. No.: 12/915,231

(22) Filed: Oct. 29, 2010

(30) Foreign Application Priority Data
Nov. 4, 2009 (JP) 2009-253420

(51) Int. Cl. H04L 9/28

(52) U.S. Cl. 380/277

(57) ABSTRACT

Disclosed is a data concealing apparatus, which makes it possible to heighten the strength of the encryption processing that employs such the data cryptography method in which the encryption of compressed image data is achieved by destroying a part of the compressed image data concerned. The data concealing apparatus includes: an establishing section to establish a data size of a portion of compressed data in a changeable manner; a cryptography key extracting section to extract the portion of compressed data from the compressed data as the cryptography key data, while making a data size of the cryptography key data coincide with the data size established by the establishing section; and an encrypting section to encrypt the compressed data by replacing the portion of compressed data, extracted as the cryptography key data by the cryptography key extracting section, with certain data being different from the cryptography key data.

This application is based on Japanese Patent Application NO. 2009-253420 filed on Nov. 4, 2009, with Japan Patent Office, the entire content of which is hereby incorporated by reference.

### BACKGROUND OF THE INVENTION

The present invention relates to a data concealing apparatus (hereinafter, also referred to as a data encryption apparatus) that encrypts data, a data decryption apparatus that decrypts encrypted data and image forming apparatus having a data encrypting function.

In recent years, most of document data and image data have been stored into a storage device, such as an HDD (Hard Disc Drive), etc., in the form of electric data being easy to handle. For instance, an image forming apparatus, such as a copier having a copy function, a MFP (Multi Function Peripheral) that is provided with various kinds of functions, such as a scanner function, a printer function, a facsimile function, etc., in addition to the copy function abovementioned, is further provided with a function for storing document data, read from a document, into a storage medium, such as a memory device, an HDD (Hard Disc Drive), etc. By using the above function, it has become possible not only to transmit the image data stored in the storage medium to an external apparatus through a communication line, but also to reprint the image represented by the image data concerned, based on the instruction issued by the user.

On the other hand, however, since the image data is stored into the image forming apparatus proper in the form of electric data, there has arisen such a threat (or danger) that a confidential document stored therein is printed out and the printed confidential document is carried away by a certain third person without any permission, confidential data classified into the top secret is transmitted to a certain outside party through an E-mail, or is carried away towards external apparatuses through a network, or the like. As the countermeasure of the abovementioned, requested is the security function to be provided in the image forming apparatus. For this purpose, there have been gradually proliferated in the market such a technology for requesting a password authentication when the user intends to take out the document stored in the image forming apparatus proper, another technology for encrypting the document data and/or the image data when the user intends to store them therein.

Since the technology for encrypting the document data and/or the image data when the user intends to store them therein has been regarded as effective for improving the security aspects of the image forming apparatus concerned, various kinds of encrypting methods have been put into practice, so far. However, since an amount of information, included in the image data to be handled in the copier, the digital MFP or the like, is very great, if the whole image data is tried to be encrypted, the processing time of the CPU (Central Processing Unit) to be occupied by the encryption processing and the decryption would increase considerably, resulting in a deterioration of the productivity as the image forming apparatus. To overcome the abovementioned problem, IC chips exclusively used for the encryption and decryption processing have been incorporated into the image forming apparatus concerned so as to alleviate the burden to the CPU. However, for this countermeasure, it is necessary to reform hardware thereof, resulting in a steep rise of the product price.

Alternatively, Tokkai 2006-166372 (Japanese Patent Application Laid-Open Publication) sets forth still another technology for preventing the image forming apparatus from injustice accesses, possibly conducted by a certain third person, without encrypting the whole image data concerned. According to the abovementioned technology, a part of image data to be stored is taken out, so as to change the address of the partial data taken out and to store the partial data in an area being separate from that of the original image data. Further, the part of the image data, from which the partial data has been taken out, is replaced (rewritten) with new data having no correlation with the partial data taken out, so as to make it difficult to decrypt the whole image data, and thereby, to improve the security aspects of the image forming apparatus concerned.

Further, when image data is stored into the MFP or the like, the compression processing is generally applied to the image data, so as to reduce a storage capacity required for storing the image data concerned. For this purpose, Tokkai 2005-20436 (Japanese Patent Application Laid-Open Publication) sets forth such a technology that the image data is compressed by employing the compressing method, which makes it impossible to achieve its expansion processing when even a part of the compressed image data is incorrect, and a part of the compressed image data is taken out from the whole compressed image data as partial compressed data, so as to store the partial compressed data into a storage area being separate from that for storing the whole compressed image data. Further, the part of the compressed image data, from which the partial compressed data has been taken out, is replaced (rewritten) with new data, or deleted, so as to make it difficult to correctly expand the whole compressed image data, and thereby, to improve the security aspects of the image forming apparatus concerned. According to the abovementioned technology, since the encryption processing is achieved by using the property of the compressed image data generated as a result of the general purpose compression processing, the additional processing, to be conducted associating with the encryption processing, can be decreased, and as a result, it becomes possible to apply the encryption processing to the image data efficiently.

According to the technologies set forth in Tokkai 2006-166372 and Tokkai 2005-20436, however, the apparatus is so constituted that, when the abovementioned partial data or the partial compressed data is taken out, it is always taken out from the same area, or at the same size. Accordingly, there has been such a fear that once a security wall of certain image data has broken by an injustice intruder, the rule employed for the encryption processing has been revealed to the injustice intruder, and as a result, other security walls of all image data stored in the MFP are also broken by employing the same rule revealed to the injustice intruder.

### SUMMARY OF THE INVENTION

To overcome the abovementioned drawbacks in conventional data concealing apparatus, it is one of objects of the present invention to provide a data concealing apparatus, a data restoring apparatus and an image forming apparatus that includes a concealing unit and a data restoring unit, each of which makes it possible to heighten the strength of the encryption processing that employs such the data cryptography method in which the encryption of compressed image data is achieved by destroying a part of the compressed image data concerned.

Accordingly, at least one of the objects of the present invention can be attained by the data concealing apparatuses and the image forming apparatuses described as follows.

(1) According to a data concealing apparatus reflecting an aspect of the present invention, the data concealing apparatus comprises: an establishing section to establish a data size of a portion of compressed data in a changeable manner, wherein the compressed data is acquired by applying a compression processing to original image data, and the compression processing employs such a data compressing method that makes it impossible to restore the original image data by applying an expansion processing to the compressed data when even a fraction of the compressed data is incorrect, and the portion of compressed data is to be carried away from the compressed data as cryptography key data; a cryptography key extracting section to extract the portion of compressed data from the compressed data as the cryptography key data, while making a data size of the cryptography key data coincide with the data size established by the establishing section; and an encrypting section to encrypt the compressed data by replacing the portion of compressed data, extracted as the cryptography key data by the cryptography key extracting section, with certain data being different from the cryptography key data.
(2) According to another aspect of the present invention, in the data concealing apparatus recited in item 1, the establishing section also establishes a carrying away position, from which the portion of compressed data is carried away from the compressed data as the cryptography key data, in a changeable manner; and the cryptography key extracting section extracts the cryptography key data from the carrying away position established by the establishing section, while making the data size of the cryptography key data coincide with the data size established by the establishing section.
(3) According to still another aspect of the present invention, in the data concealing apparatus recited in item 1, the cryptography key extracting section creates plural sets of cryptography key data by extracting plural portions of the compressed data from plural carrying away positions of the compressed data, including a leading top position, and a single position or plural positions, both other than the leading top position; and with respect to at least one of the plural carrying away positions, the establishing section establishes the data size.
(4) According to still another aspect of the present invention, in the data concealing apparatus recited in item 1, the establishing section accepts an inputted setting content, and establishes a setting content of the cryptography key data to be extracted by the cryptography key extracting section, based on the inputted setting content accepted in advance.
(5) According to still another aspect of the present invention, in the data concealing apparatus recited in item 1, the establishing section stores the data size as encryption history information, therein, so as to determine the data size while referring to the encryption history information
(6) According to still another aspect of the present invention, in the data concealing apparatus recited in item 1, the encrypting section encrypts the compressed data by deleting the portion of compressed data, extracted as the cryptography key data, instead of by replacing the portion of compressed data with the certain data being different from the cryptography key data.
(7) According to still another aspect of the present invention, in the data concealing apparatus recited in item 1, the establishing section establishes the data size at one of randomly changed values.
(8) According to an image forming apparatus reflecting still another aspect of the present invention, the image forming apparatus, comprises: a reading section that reads a document to acquire image data representing an image of the document; a compression processing section that applies compression processing to the image data to generate compressed data, wherein the compression processing employs such a data compressing method that makes it impossible to restore the original image data by applying an expansion processing to the compressed data when even a fraction of the compressed data is incorrect; a data concealing unit that comprises an establishing section to establish a data size of a portion of compressed data in a changeable manner wherein the portion of compressed data is to be carried away from the compressed data as cryptography key data, a cryptography key extracting section to extract the portion of compressed data from the compressed data as the cryptography key data while making a data size of the cryptography key data coincide with the data size established by the establishing section, and an encrypting section to encrypt the compressed data by replacing the portion of compressed data, extracted as the cryptography key data by the cryptography key extracting section, with certain data being different from the cryptography key data, so as to generate encrypted compression data; a cryptography key storing section to store the cryptography key data extracted from the compressed data by the cryptography key extracting section provided in the data concealing unit, therein; an encrypted compression data storing section to store the encrypted compression data generated by the encrypting section provided in the data concealing unit, therein; a coupling information storing section to store coupling information representing a correlation between the cryptography key data and the encrypted compression data, therein; a carrying-away area storing section to store the data size of the cryptography key data, therein, while correlating the data size with the encrypted compression data generated from the compressed data; a data restoring unit that acquires the cryptography key data from the cryptography key storing section, the encrypted compression data from the encrypted compression data storing section and the data size from the carrying-away area storing section, to combine the cryptography key data and the encrypted compression data with each other based on the cryptography key data, the encrypted compression data and the data size so as to restore the encrypted compression data to the compressed data originally generated by the compression processing section; an expansion processing section to apply an expansion processing to the compressed data restored by the data restoring unit, so as to restore the compressed data to the image data originally acquired by the reading section; and a printing section to form the image, represented by the image data restored by the expansion processing section, onto a recording paper sheet, and then, to output the recording paper sheet on which the image is formed.
(9) According to an image forming apparatus reflecting yet another aspect of the present invention, the image forming apparatus, comprises: a reading section that reads a document to acquire image data representing an image of the document; a compression processing section that applies compression processing to the image data to generate compressed data, wherein the compression processing employs such a data compressing method that makes it impossible to restore the original image data by applying an expansion processing to the compressed data when even a fraction of the compressed data is incorrect; a data concealing unit that comprises an establishing section to establish a carrying away position of compressed data in a changeable manner wherein a portion of compressed data is to be carried away from the carrying away position as cryptography key data, a cryptography key extracting section to extract the portion of compressed data from the carrying away position of the compressed data as the cryptography key data, and an encrypting section to encrypt the compressed data by replacing the portion of compressed data, extracted as the cryptography key data by the cryptography key extracting section, with certain data being different from the cryptography key data, so as to generate encrypted compression data; a cryptography key storing section to store the cryptography key data extracted from the compressed data by the cryptography key extracting section provided in the data concealing unit, therein; an encrypted compression data storing section to store the encrypted compression data generated by the encrypting section provided in the data concealing unit, therein; a coupling information storing section to store coupling information representing a correlation between the cryptography key data and the encrypted compression data, therein; a carrying-away area storing section to store the carrying away position of the cryptography key data, therein, while correlating the carrying away position with the encrypted compression data generated from the compressed data; a data restoring unit that acquires the cryptography key data from the cryptography key storing section, the encrypted compression data from the encrypted compression data storing section and the carrying away position from the carrying-away area storing section, to combine the cryptography key data and the encrypted compression data with each other based on the cryptography key data, the encrypted compression data and the carrying away position so as to restore the encrypted compression data to the compressed data originally generated by the compression processing section; an expansion processing section to apply an expansion processing to the compressed data restored by the data restoring unit, so as to restore the compressed data to the image data originally acquired by the reading section; and a printing section to form the image, represented by the image data restored by the expansion processing section, onto a recording paper sheet, and then, to output the recording paper sheet on which the image is formed.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 shows an explanatory schematic diagram indicating a principle and a data flow of an encryption processing and a decryption processing, embodied in the present invention;

FIG. 2 shows a block diagram indicating a configuration of an image forming apparatus embodied in the present invention;

FIG. 3 shows a flowchart indicating a processing flow, which is to be implemented in an image forming apparatus embodied in the present invention, for compressing and encrypting page-image data representing a page-image residing within a first page, and then, storing the processed image data;

FIG. 4 shows an explanatory schematic diagram indicating transitions of the page-image data according to the processing flow in the flowchart shown in FIG. 3;

FIG. 5 shows a flowchart indicating a processing flow, which is to be implemented in an image forming apparatus embodied in the present invention, for compressing and encrypting page-image data representing a page-image residing within a second page or a later page, and then, storing processed page-image data;

FIG. 6 shows an explanatory schematic diagram indicating transitions of the page-image data according to the processing flow in the flowchart shown in FIG. 5;

FIG. 7 shows a flowchart indicating a processing flow, which is to be implemented in the image forming apparatus embodied in the present invention as the second embodiment, for compressing and encrypting page-image data representing a page-image residing within a second page or a later page, and then, storing the processed page-image data;

FIG. 8 shows an explanatory schematic diagram indicating transitions of the page-image data according to the processing flow in the flowchart shown in FIG. 7;

FIG. 9 shows a flowchart indicating a processing flow, which is to be implemented in an image forming apparatus embodied in the present invention as the third embodiment, for compressing and encrypting page-image data representing a page-image residing within a second page or a later page, and then, storing the processed page-image data;

FIG. 10 shows an explanatory schematic diagram indicating transitions of the page-image data according to the processing flow in the flowchart shown in FIG. 9;

FIG. 11 shows a flowchart indicating a processing flow, which is to be implemented in an image forming apparatus embodied in the present invention as the fourth embodiment, for compressing and encrypting page-image data representing a page-image residing within a second page or a later page, and then, storing the processed page-image data;

FIG. 12 shows an explanatory schematic diagram indicating transitions of the page-image data according to the processing flow in the flowchart shown in FIG. 11;

FIG. 13 shows a flowchart indicating a processing flow, which is to be implemented in an image forming apparatus embodied in the present invention as the fifth embodiment, for compressing and encrypting page-image data representing a page-image residing within a second page or a later page, and then, storing the processed page-image data;

FIG. 14 shows an explanatory schematic diagram indicating transitions of the page-image data according to the processing flow in the flowchart shown in FIG. 13;

FIG. 15 shows a flowchart indicating a processing flow, which is to be implemented in an image forming apparatus embodied in the present invention as the sixth embodiment, for compressing and encrypting page-image data representing a page-image residing within a second page or a later page, and then, storing the processed page-image data;

FIG. 16 shows an explanatory schematic diagram indicating transitions of the page-image data according to the processing flow in the flowchart shown in FIG. 15; and

FIG. 17 shows an explanatory schematic diagram indicating a principle and a data flow of an encryption processing and a decryption processing, embodied in the present invention as the seventh embodiment.

### DETAILED DESCRIPTION OF THE PREFERRED EMBODIMENT

Referring to the drawings, various kinds of embodiments of the present invention will be detailed in the following.

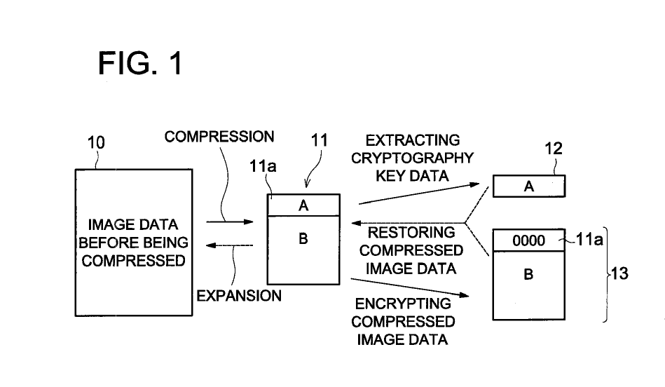

FIG. 1 shows a schematic diagram indicating a principle of the encryption and decryption processing. The bold arrows and the broken arrows, both shown in FIG. 1, indicate a data processing flow when applying the compression and encryption processing, and another data processing flow when applying the decryption and expansion processing, respectively. According to present invention, when image data 10 is compressed, and then, compressed image data 11 is stored, a part of the compressed image data 11 is carried away, and is established as cryptographic key data 12.

In the example shown in FIG. 1, a data section 11a, being a predetermined range portion from the leading edge of the compressed image data 11, is carried away so as to make it serve as the cryptographic key data 12. On the other hand, the compressed image data 11 is encrypted by replacing the data section 11a with other data, which is made to be different from the original value by applying the zero clearing operation or the like, so as to convert the compressed image data 11 to encrypted image data 13.

The encrypted image data 13 can be decrypted to the compressed image data 11 by returning the cryptographic key data 12 to the data section 11a, which has been destroyed by applying the zero clearing operation or the like. Then, by applying the expansion processing to the compressed image data 11 decrypted in the above, the image data 10 before compression is regenerated.

The image data 10 is compressed to the compressed image data 11 by employing such a compression method that makes it impossible to correctly expand the compressed image data 11 as a whole, when even a part of the compressed image data 11 is incorrect. For instance, the LZ compression method or the like may be employed for this purpose. In the LZ compression method, if data to be compressed has not previously emerged, the concerned data is registered as a dictionary, while, if the concerned data has already emerged, the concerned data is compressed by memorizing the position and the length of the dictionary to which the same data is registered. To achieve the expansion of the compressed image data generated by employing the compression method as abovementioned, it is necessary to compare each of data with previous data. Accordingly, when the previous data or the dictionary has been destroyed, it becomes impossible to expand the concerned data to the original data.

Therefore, since the encrypted image data 13, in which a part of the compressed image data 11 is replaced with the data having a value different from the original value, cannot be expanded as it is, the compressed image data 11 can be encrypted by employing such an easy method that is the partially replacing method as abovementioned. In addition, according to the present invention, by changing the data size of the data section 11a and/or a carrying away position, the complexity of the cryptographic operation is heightened so as to improve the security aspects of the image forming apparatus concerned.

In this connection, the scope of the compression method is not limited to the LZ compression method abovementioned. Any other compression method may be applicable in the present invention, as far as the concerned method is such a method that it is necessary to refer the previous data in the expansion processing or it is impossible to achieve the expansion processing when even a part of compressed image data is incorrect.

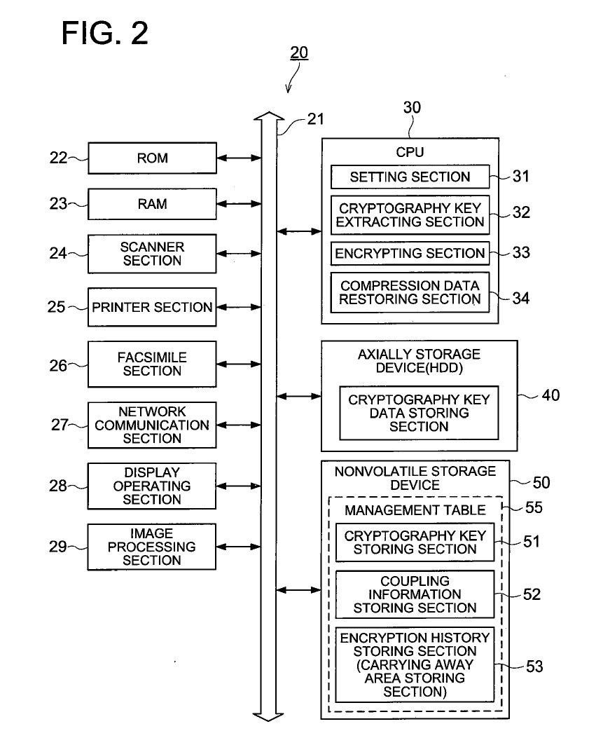

FIG. 2 shows a block diagram indicating a configuration of an image forming apparatus 20, which includes the data concealing apparatus embodied in the present invention. The image forming apparatus 20 is constituted by a CPU (Central Processing Unit) 30, a ROM (Read Only Memory) 22, a RAM (Random Access Memory) 23, a scanner section 24, a printer section 25, a facsimile section 26, a network communication section 27, a display operating section 28, an image processing section 29, an axially storage device 40, and a nonvolatile storage device 50, which are coupled to each other through a bus 21.

Further, the image forming apparatus 20 serves as a digital MFP (Multi Function Peripheral) that is provided with: a function for applying the compression and encryption processing, or only the compression processing, to image data acquired by reading a document, so as to stored the processed image data therein; another function for transmitting the compressed and encrypted image data to an external apparatus by using an E-mail or an FTP (File Transfer Protocol); still another function for retrieving a specific image data from the storage so as to print an image represented by the specific image data onto a recording medium; etc.

The CPU 30 serves as a controlling section to totally control the various kinds of operations to be conducted in the image forming apparatus 20, an image data concealing (encryption) apparatus that encrypts image data and a data restoring (decryption) apparatus that decrypts the encrypted image data.

The ROM 22 stores various kinds of programs therein. The CPU 30 conducts various kinds of processing by executing the programs stored in the ROM 22, so as to serve as the controlling section, the image data concealing apparatus and the data restoring apparatus, above-mentioned.

The RAM 23 serves as a random access memory to be utilized as a working memory to temporarily store various kinds of data when the CPU 30 executes the programs, a page memory to store image data for at least a single page to apply the rotation processing or the like to the image data concerned, a communication buffer memory to temporarily store data in regard to transmission and reception processing, etc.

The scanner section 24 optically reads a document image so as to acquire image data representing the document image. The scanner section 24 is constituted by: a light source to emit light to be irradiated onto the document; a line image sensor to receive the light reflected from the document so as to read the document image every one of scanning lines in its width direction; a document shifting mechanism to sequentially shift the reading position in the longitudinal direction of the document one by one in a unit of one scanning line; an optical path that includes various kinds of optical elements, such as lenses, mirrors, etc., to guide the light reflected from the document to the line image sensor so as to focus the light thereon; an analogue to digital converting section to convert analogue signals, outputted by the line image sensor, to digital image data, etc.

The printer section 25 serves as a printing section to print an image represented by the digital image data onto a recording paper sheet. In the present embodiment, the printer section 25 is configured as, so called, a laser printer that is constituted by a conveyance mechanism for conveying the recording paper sheet, a photoreceptor drum, a charging device, a laser unit, a developing device, a transferring device, a separation device, a cleaning device and a fixing device, in order to implement the image forming operation through the electro-photographic process.

The facsimile section 26 conducts various kinds of communication controlling operations for implementing the facsimile transmission and the facsimile reception, an operation for implementing a call request, an operation for implementing a call-in, an operation for connecting the apparatus to the public telephone line, etc.

The network communication section 27 serves as an interface for bilaterally communicating with a terminal device, such as a personal computer, etc., a server, etc., through a network, such as a LAN (Local Area Network), etc., so as to conduct operations for transmitting and receiving various kinds of data and information thereto/from.

The display operating section 28 serves as both a display device that displays various kinds of operating and setting screens, a guidance screen, a warning screen, etc., thereon as user interface, and an operating section that accepts various kinds of setting operations to be conducted by the user, including operations for encrypting data, and notifies the CPU 30 of contents of the instructions and settings inputted by the user. For instance, the display operating section 28 is constituted by a LCD (Liquid Crystal Display), a touch panel mounted over the LCD, ten keys, a start button, function mode keys, etc.

The image processing section 29 is provided with a function for conducting the rasterize processing to convert print data received from the terminal device located outside the apparatus, the image rotation processing, etc. Further, the image processing section 29 also serves as both a compression section to apply a compression processing to the image data and an expansion section to apply an expansion processing to the image data.

The axially storage device 40 serves as a nonvolatile mass storage device that stores a large sized data having a large amount of information, such as image data, etc., therein. This axially storage device 40 is constituted by, for instance, an HDD (Hard Disc Drive), etc. The nonvolatile mass storage device is defined as such a storage that retains information currently stored therein even after the electric power supplied from the power source has been turned OFF.

Concretely speaking further, the CPU 30 serves as a setting section 31, a cryptography key extracting section 32, an encrypting section 33 and a compression data restoring section 34.

The setting section 31 establishes the data size and the carrying away position (such as an offset from the address position or a leading top position of the compressed data, etc.) of the cryptography key data to be carried away from the compression data as aforementioned by referring to FIG. 1. Further, the setting section 31 changes at least any one of setting values of the data size and the carrying away position, both established in advance by itself, based on various kinds of conditions including, for instance, results of comparing them with the contents of the past (previous) settings, an instruction inputted by the user, etc.

The cryptography key extracting section 32 carries away the part of the compressed data as the cryptography key data, according to the settings established by the setting section 31.

The encrypting section 33 replaces the part of the compressed data, carried away as the cryptography key data, with certain data being different from the cryptography key data concerned or deletes and destroys the carried away part of the compressed data, so as to convert the compressed data to the encrypted data acquired by encrypting the compressed data. The encrypted data generated by the encrypting section 33 is stored into the axially storage device 40 serving as an encrypted data storing section.

The compression data restoring section 34 combines the cryptography key data and the encrypted data with each other to restore the original compressed image data.

The nonvolatile storage device 50 serves as a cryptography key storing section 51 that stores the cryptography key data extracted by the cryptography key extracting section 32 therein, a coupling information storing section 52, and a encryption history storing section 53.

The coupling information storing section 52 stores coupling information representing the correlation between the cryptography key data and the encrypted data, both of which are acquired from the same compressed data, therein. The encryption history storing section 53 stores the size information, representing the data size of the cryptography key data carried away from the compressed image data, and the address information representing its carrying away position, therein, while correlating them with either the cryptography key data or the encrypted data corresponding to the cryptography key data concerned.

In the present embodiment, the functions to be conducted by the cryptography key storing section 51, the coupling information storing section 52 and the encryption history storing section 53 are integrated into a management table 55. The apparatus is so constituted that the encrypted data is stored into the axially storage device 40 as a file, and a file name of the encrypted data file, the cryptography key data to be employed for restoring the encrypted data concerned, and management information in which the size information of the cryptography key data and the address information thereof are correlated with each other, are stored into the management table 55. In this connection, hereinafter, the size information of the cryptography key data and the address information thereof, both included in the management information, are referred to as the encryption history information.

Next, operations to be implemented by the image forming apparatus 20, for compressing, encrypting and storing image data, will be detailed in the following. Herein, such a case that the compressing and encrypting processing are applied to image data representing a plural page-images corresponding to plural pages of a document, will be detailed in the following.

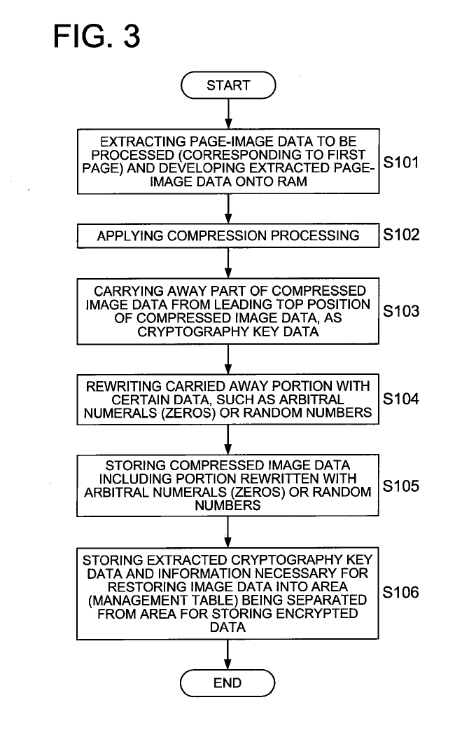

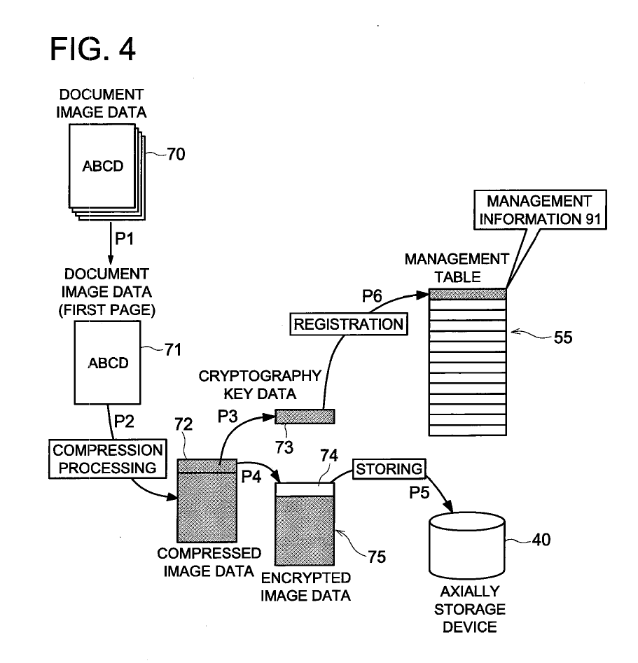

FIG. 3 shows a flowchart indicating a processing flow, which is to be implemented in the image forming apparatus 20, for compressing and encrypting page-image data representing a page-image residing within a first page of a processing objective document, and then, storing the processed image data, while, FIG. 4 shows a schematic diagram indicating transitions of the page-image data according to the processing flow in the flowchart shown in FIG. 3.

Initially, the CPU 30 of the image forming apparatus 20 extracts page-image data 71 (in this example, page-image data corresponding to the first page) to be employed as the processing object, from image data 70 acquired by reading the document, so as to develop the page-image data 71 onto the RAM 23 (Step S101 shown in FIG. 3, and P1 shown in FIG. 4). Successively, the CPU 30 makes the image processing section 29 compress the page-image data 71, developed in the RAM 23, by employing the aforementioned compression method, so as to generate compressed image data 72, an then, stores the compressed image data 72 concerned into a storage area being separate from that for storing the page-image data 71 serving as the original page-image data (Step S102 shown in FIG. 3, and P2 shown in FIG. 4).

Still successively, the CPU 30 serving as the cryptography key extracting section 32 carries away a part of the compressed image data 72, corresponding to a partial area from the leading top position of compressed image data 72, as cryptography key data 73 (Step S103 shown in FIG. 3, and P3 shown in FIG. 4). In this example, the setting section 31 arbitrarily establishes the data size of the cryptography key data, which is to be carried away from the page-image data of the first page, by using random numbers or the like.

Still successively, the encrypting section 33 rewrites a carried away portion 74, which is corresponds to the data area carried away from the compressed image data 72 as the cryptography key data 73 by the cryptography key extracting section 32, with certain data, such as arbitral numerals, random numbers or the like, having no correlation with the cryptography key data 73 (original data) (Step S104 shown in FIG. 3, and P4 shown in FIG. 4). Then, the CPU 30 makes a file for the above-rewritten compressed image data as the file of encrypted image data 75, so as to store it into the axially storage device 40 (Step S105 shown in FIG. 3, and P5 shown in FIG. 4).

Yet successively, the CPU 30 generates management information 91 in which the file name of the encrypted image data 75, the cryptography key data 73, and the size information and the address information of the cryptography key data 73 carried away form the page-image data 71, are correlated with each other, and registers the management information 91 above-generated into the management table 55 (Step S106 shown in FIG. 3, and P6 shown in FIG. 4) to finalize the current processing (END). In this connection, since the CPU 30 dynamically secures the area for storing the management table 55 (address to be stored) from the currently vacant storage area of the nonvolatile storage device 50, it is impossible, according to the normal procedures, to read out the contents of the management table 55 from an outside environment.

Next, operations to be implemented by the image forming apparatus 20, for compressing and encrypting page-image data representing a page-image residing within a second page or a later page of the processing objective document, and then, storing the processed page-image data, will be detailed in the following.

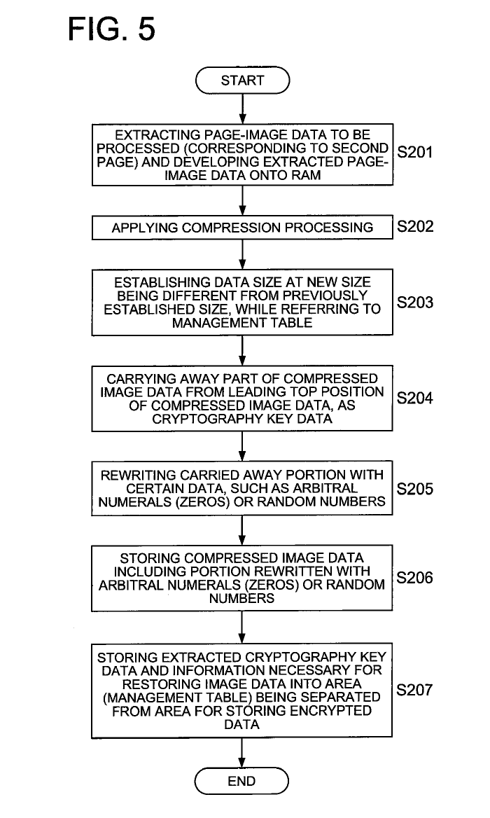

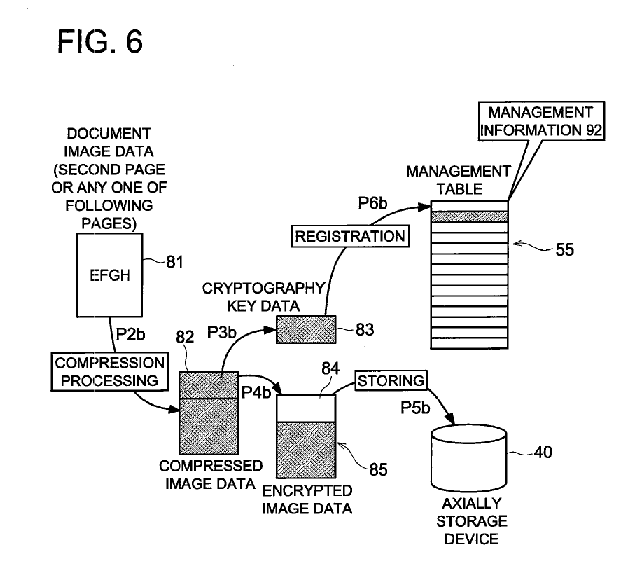

FIG. 5 shows a flowchart indicating a processing flow, which is to be implemented in the image forming apparatus 20, for compressing and encrypting page-image data representing a page-image residing within a second page or a later page of the processing objective document, and then, storing the processed page-image data, while, FIG. 6 shows a schematic diagram indicating transitions of the page-image data according to the processing flow in the flowchart shown in FIG. 5.

Initially, the CPU 30 of the image forming apparatus 20 extracts page-image data 81 to be employed as the processing object (page-image data corresponding to the second page or any one of the following pages, herein, defined as the page-image data corresponding to the second page), from image data 70, so as to develop the page-image data 81 onto the RAM 23 (Step S201 shown in FIG. 5). Successively, the CPU 30 makes the image processing section 29 compress the page-image data 81, developed in the RAM 23, by employing the aforementioned compression method, so as to generate compressed image data 82, an then, stores the compressed image data 82 concerned into a storage area being separate from that for storing the page-image data 81 serving as the original page-image data (Step S202 shown in FIG. 5, and P2b shown in FIG. 6).

Successively, the setting section 31 of the CPU 30 establishes the data size of the portion to be carried away as the cryptography key data from the compressed image data 82 at a new size being different from the previously established size (Step S203 shown in FIG. 5). Concretely speaking, the setting section 31 finds a candidate value of the data size by using random numbers, a predetermined function or the like. Then, the setting section 31 reads the management information registered in the management table 55, in order to sequentially compare the above-found candidate value with the data sizes included in the management information. As a result of the comparison, when determining that the data size, having the value same as that of the above-found candidate value, has been already registered in the management table 55, the setting section 31 again finds another candidate value of the data size by using random numbers, a predetermined function or the like, and repeats the abovementioned process until the data size having the value same as that of the currently-found candidate value cannot be found in the management table 55. Finally, when determining that the data size, having the value same as that of the above-found candidate value, is not registered in the management table 55, the setting section 31 establishes the currently-found candidate value as that of the data size of the cryptography key data 83 to be currently carried away.

In this connection, it is applicable that the system is so constituted that, when the currently-found candidate value is different from those of all data sizes registered in the management table 55, the setting section 31 employs the currently-found candidate value concerned, or when the currently-found candidate value is different from those of several data sizes among all of the data sizes registered in the management table 55, the setting section 31 employs the currently-found candidate value concerned. For instance, it is also applicable that the system is so constituted that, when the currently-found candidate value is different from that of the data size indicated by the management information that is previously registered (data size of the cryptography key data of the previous page) among the management information registered in the management table 55, the setting section 31 employs the currently-found candidate value concerned.

Still successively, the cryptography key extracting section 32 of the CPU 30 carries away the cryptography key data 83 from the leading top position of the compressed image data 82 in accordance with the data size established by the setting section 31 as abovementioned (Step S204 shown in FIG. 5, and P3b shown in FIG. 6).

Still successively, the encrypting section 33 rewrites a carried away portion 84, which is corresponds to the data area carried away from the compressed image data 82 as the cryptography key data 83 by the cryptography key extracting section 32, with certain data, such as zeros or arbitral numerals, random numbers or the like, having no correlation with the cryptography key data 83 (original data) (Step S205 shown in FIG. 5, and P4b shown in FIG. 6). Then, the CPU 30 makes a file for the above-rewritten compressed image data as the file of encrypted image data 85, so as to store it into the axially storage device 40 (Step S206 shown in FIG. 5, and P5b shown in FIG. 6).

Yet successively, the CPU 30 generates management information 92 in which the file name of the encrypted image data 85, the cryptography key data 83, and the size information and the address information of the cryptography key data 83, carried away form the page-image data 81, are correlated with each other, and registers the management information 92, above-generated, into the management table 55 (Step S207 shown in FIG. 5, and P6b shown in FIG. 6) to finalize the current processing (END).

In this connection, the CPU 30 of the image forming apparatus 20 applies the processing, being same as those indicated in the flowchart shown in FIG. 5 and the schematic diagram shown in FIG. 6, to the page-image data of the third page and every one of the following pages.

As described in the foregoing, since the carried away portions 74, 84, carried away from the encrypted image data 75, 85, are rewritten with the data having no correlation with the cryptography key data of them, it is impossible to correctly expand the encrypted image data 75, 85, which is acquired by compressing and encrypting the original image data, to the original image data. Accordingly, even if the injustice intruder (or a third person) takes advantage of a certain injustice method to retrieve and obtain the encrypted image data 75, 85, currently stored in the axially storage device 40, it is impossible for the injustice intruder to correctly expand and restore the encrypted image data 75, 85 to the original image data only by itself. Therefore, it becomes possible to acquire a high security efficiency of the image forming apparatus 20.

Further, since the normal user (including the injustice intruder) knows neither the management method to be conducted in the image forming apparatus 20 for controlling the cryptography key data 73, 83, nor the storage area (address) into which the cryptography key data 73, 83 are stored, it is quite difficult for the normal user to obtain the cryptography key data 73, 83, even if he intends to use a certain injustice measure. In the present embodiment, since the cryptography key data 73, 83 are stored into such the storage areas that are separate from those for storing the encrypted image data 75, 85 (namely, the cryptography key data is stored into the nonvolatile storage device 50, while the encrypted image data is stored into the axially storage device 40), and in addition, the storage areas of them (management table 55) are dynamically secured, it is quite difficult to read out them from the outside environment. Accordingly, it becomes possible to secure the high security efficiency, higher than ever. In this connection, the lager the amount of data to be carried away as the cryptography key data 73, 83 is, the higher the security efficiency is improved.

Still further, since the leading top portions of the compressed image data 72, 82 are destroyed by applying the zero clear processing or the like, any kind of expansion processing cannot be applied to the encrypted image data 75, 85 from its beginning, and as a result, it becomes possible to strongly protect the image data from its unauthorized leakage.

Still further, since the system is so constituted that the data size of the cryptography key data, which is to be carried away from the leading top position, can be randomly changed, the complexity of encryption processing is still heightened, so as to improve the security aspect of the encrypted image data against the attack set up by the third person or the injustice intruder. Specifically, since the used data sizes have been registered into the management table 55 so as to avoid the repeated usage of the data size same as that previously used, it becomes possible to establish the data sizes so as to make them securely different from each other. According to this feature, even in case that a security wall of a certain page has been broken, it becomes possible to protect the security walls of the following pages from continuously being broken by using the same way, resulting in improvement of the security aspect of encrypted image data.

Yet further, according to the method for setting the data size of the cryptography key data at the value being different from the previous value, compared to such the case that all of the differences between the concerned data size and the other data sizes included in the management table 55 should be found, the processing burden of the CPU 30 would be drastically reduced, due to the reduction of the amount of data to be compared. In addition, when the candidate value is selected by using the random numbers or the like, it becomes possible to heighten the encryption strength by giving a sufficiently random value to each of the pages included in the document concerned.

Next, the second embodiment of the present invention will be detailed in the following. In this connection, the operations to be conducted in the second embodiment for processing the first page are the same as those of the first embodiment aforementioned.

In the first embodiment, the data size of the cryptography key data, corresponding to the second page or any one of the following pages, is established in such a manner that the value of the new data size is different from those of the previously established cryptography key data. On the other hand, in the second embodiment, the carrying away position of the cryptography key data, corresponding to the second page or any one of the following pages, is established in such a manner that the new carrying away position is different from those of the previously established cryptography key data.

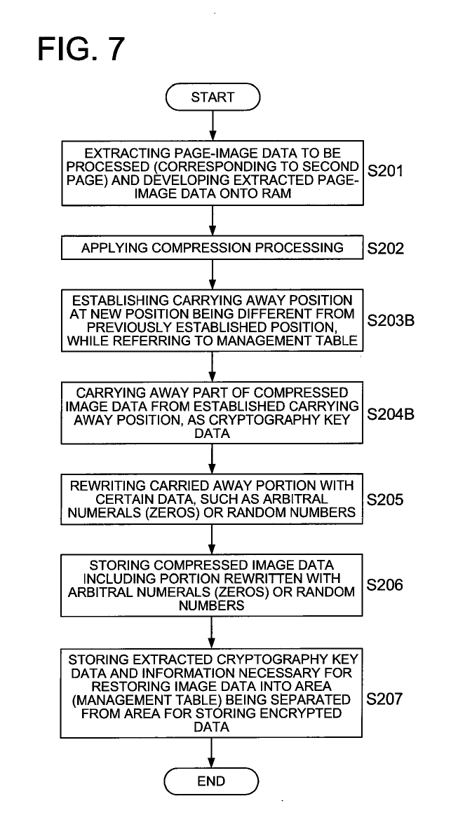

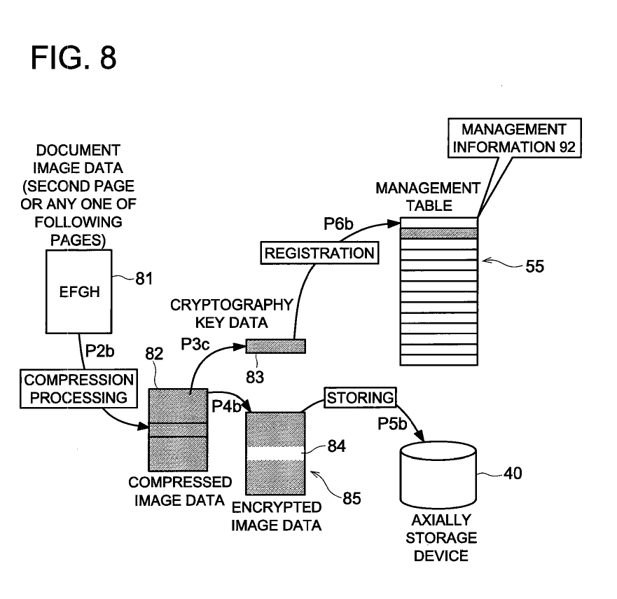

FIG. 7 shows a flowchart indicating a processing flow, which is to be implemented in the image forming apparatus 20, for compressing and encrypting page-image data representing a page-image residing within the second page or the later page of the processing objective document, and then, storing the processed page-image data, while, FIG. 8 shows a schematic diagram indicating transitions of the page-image data according to the processing flow in the flowchart shown in FIG. 7.

In this connection, the same step number is attached to the same steps indicated in the flowcharts respectively shown in FIG. 7 and FIG. 5. Further, the same process number is attached to the same processes indicated in the schematic diagrams respectively shown in FIG. 8 and FIG. 6.

Initially, the CPU 30 extracts page-image data 81 to be employed as the processing object (page-image data corresponding to the second page or any one of the following pages, herein, defined as the page-image data corresponding to the second page), from image data 70, so as to develop the page-image data 81 onto the RAM 23 (Step S201 shown in FIG. 7). Successively, the CPU 30 makes the image processing section 29 compress the page-image data 81 developed in the RAM 23, so as to generate compressed image data 82, an then, stores the compressed image data 82 concerned into a storage area being separate from that for storing the page-image data 81 serving as the original page-image data (Step S202 shown in FIG. 7, and P2b shown in FIG. 8). Still successively, the setting section 31 of the CPU 30 establishes the carrying away position of the portion to be carried away as the cryptography key data from the compressed image data 82 at a new carrying away position being different from the previous carrying away position established previously (Step S203B shown in FIG. 7).

Concretely speaking, the setting section 31 finds a candidate value of the carrying away position by using random numbers, a predetermined function or the like. Then, the setting section 31 reads the management information registered in the management table 55, in order to sequentially compare the above-found candidate value with values of the carrying away positions included in the management information. As a result of the comparison, when determining that the carrying away position, having the value same as that of the above-found candidate value, has been already registered in the management table 55, the setting section 31 again finds another candidate value of the carrying away position by using random numbers, a predetermined function or the like, and repeats the abovementioned process until the carrying away position having the value same as that of the currently-found candidate value cannot be found in the management table 55. Finally, when determining that the carrying away position, having the value same as that of the above-found candidate value, is not registered in the management table 55, the setting section 31 establishes the currently-found candidate value as that of the carrying away position of the cryptography key data 83 to be currently carried away.

In this connection, it is applicable that the system is so constituted that, when the currently-found candidate value is different from those of all carrying away positions registered in the management table 55, the setting section 31 employs the currently-found candidate value concerned, or when the currently-found candidate value is different from those of several carrying away positions among all of the carrying away positions registered in the management table 55, the setting section 31 employs the currently-found candidate value concerned. For instance, it is also applicable that the system is so constituted that, when the currently-found candidate value is different from that of the carrying away position indicated by the management information that is previously registered (carrying away position of the cryptography key data of the previous page) among the management information registered in the management table 55, the setting section 31 employs the currently-found candidate value concerned.

Further, in the second embodiment, the system is so constituted that the setting section 31 arbitrarily establishes the data size of the cryptography key data 83 to be carried away from the compressed image data 82 by employing the random numbers or the like.

Successively, the cryptography key extracting section 32 of CPU 30 carries away the cryptography key data 83 from the carrying away position of the compressed image data 82 in accordance with the carrying away position and the data size, both established by the setting section 31 by employing the random numbers or the like as abovementioned (Step S204B shown in FIG. 7, and P3c shown in FIG. 8).

Still successively, the encrypting section 33 rewrites a carried away portion 84, which is corresponds to the data area carried away from the compressed image data 82 as the cryptography key data 83 by the cryptography key extracting section 32, with certain data, such as zeros or arbitral numerals, random numbers or the like, having no correlation with the cryptography key data 83 currently carried away (original data) (Step S205 shown in FIG. 7, and P4b shown in FIG. 8). Then, the CPU 30 creates a file for the above-rewritten compressed image data as the file of encrypted image data 85, so as to store it into the axially storage device 40 (Step S206 shown in FIG. 7, and P5b shown in FIG. 8).

Yet successively, the CPU 30 generates management information 92 in which the file name of the encrypted image data 85, the cryptography key data 83, and the size information and the address information of the cryptography key data 83, carried away form the page-image data 81, are correlated with each other, and registers the management information 92, above-generated, into the management table 55 (Step S207 shown in FIG. 7, and P6b shown in FIG. 8) to finalize the current processing (END).

In this connection, the CPU 30 of the image forming apparatus 20 applies the processing, being same as those indicated in the flowchart shown in FIG. 7 and the schematic diagram shown in FIG. 8, to the page-image data of the third page and every one of the following pages.

As described in the above, since the system is so constituted that the carrying away position of the cryptography key data can be randomly changed, it becomes possible to sequentially apply encryption processing operations, the encryption rules of which are different from each other for every page, to the pages included in the processing objective document, respectively. Specifically, since the used carrying away positions have been registered into the management table 55 so as to avoid the repeated usage of the carrying away position same as that previously used, it becomes possible to establish the carrying away positions so as to make them securely different from each other. According to this feature, even in case that a security wall of a certain page has been broken, it becomes possible to protect the security walls of the following pages from continuously being broken by using the same way, resulting in improvement of the security aspect of encrypted image data.

Further, according to the method for setting the carrying away position of the cryptography key data at the value being different from the previous value, compared to such the case that all of the differences between the concerned carrying away position and the other carrying away positions included in the management table 55 should be found, the processing burden of the CPU 30 will be drastically reduced, due to the reduction of the amount of data to be compared. In addition, when the candidate value is selected by using the random numbers or the like, it becomes possible to heighten the encryption strength by giving a sufficiently random value to each of the pages included in the document concerned as far as it is secured that the current value is securely different from the previous value.

Next, the third embodiment of the present invention will be detailed in the following. In this connection, the operations to be conducted in the third embodiment for processing the first page are the same as those of the first embodiment aforementioned.

In the third embodiment, both the data size and the carrying away position of the cryptography key data, corresponding to the second page or any one of the following pages, are established in such a manner that the new values of them are different from those of the previously established cryptography key data.

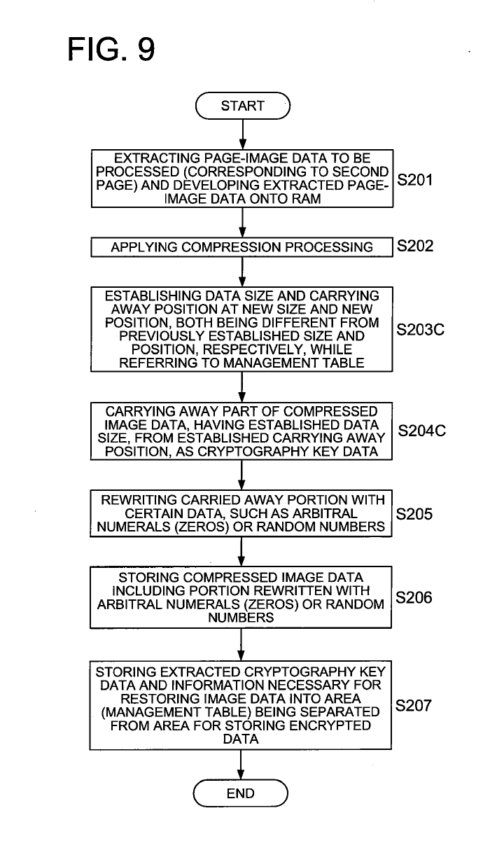

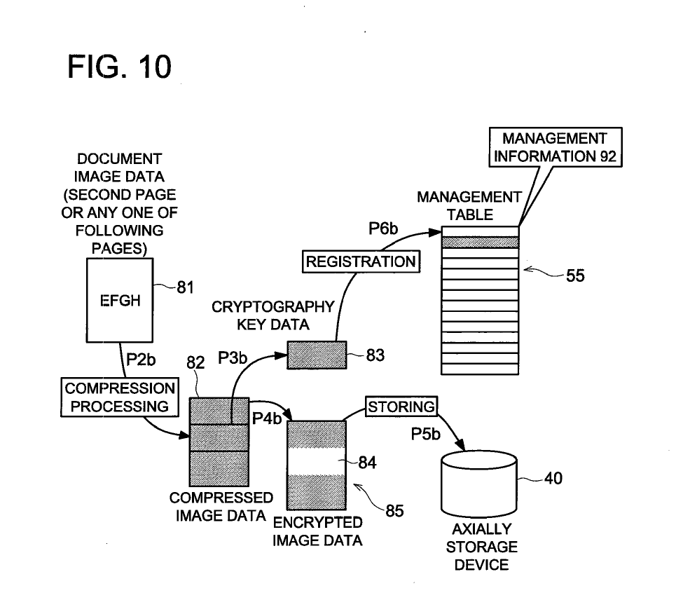

FIG. 9 shows a flowchart indicating a processing flow, which is to be implemented in the image forming apparatus 20, for compressing and encrypting page-image data representing a page-image residing within the second page or the later page of the processing objective document, and then, storing the processed page-image data, while, FIG. 10 shows a schematic diagram indicating transitions of the page-image data according to the processing flow in the flowchart shown in FIG. 9.

In this connection, the same step number is attached to the same steps indicated in the flowcharts respectively shown in FIG. 9 and FIG. 5. Further, the same process number is attached to the same processes indicated in the schematic diagrams respectively shown in FIG. 10 and FIG. 6.

Initially, the CPU 30 extracts page-image data 81 to be employed as the processing object (page-image data corresponding to the second page or any one of the following pages, herein, defined as the page-image data corresponding to the second page), from image data 70, so as to develop the page-image data 81 onto the RAM 23 (Step S201 shown in FIG. 9). Successively, the CPU 30 makes the image processing section 29 compress the page-image data 81 developed in the RAM 23, so as to generate compressed image data 82, an then, stores the compressed image data 82 concerned into a storage area being separate from that for storing the page-image data 81 serving as the original page-image data (Step S202 shown in FIG. 9, and P2b shown in FIG. 10). Still successively, the setting section 31 of the CPU 30 establishes both the data size and the carrying away position of the portion, to be carried away as the cryptography key data from the compressed image data 82, at new values being different from the previous values at which the previous data size and the previous carrying away position established, respectively (Step S203C shown in FIG. 9).

Concretely speaking, the setting section 31 finds candidate values of both the data size and the carrying away position by using random numbers, a predetermined function or the like. Then, the setting section 31 reads the management information registered in the management table 55, in order to sequentially compare the above-found candidate values with values of the data sizes and the carrying away positions included in the management information. As a result of the comparison, when determining that at least one of the data sizes and the carrying away position, having the value same as that of the above-found candidate value, has been already registered in the management table 55, the setting section 31 again finds another candidate values of them by using random numbers, a predetermined function or the like, and repeats the abovementioned process until none of the data sizes and the carrying away positions, having the values same as those of the currently-found candidate values, can be found in the management table 55. Finally, when determining that the data sizes and the carrying away position, having the values same as those of the above-found candidate values, are not registered in the management table 55, the setting section 31 establishes the currently-found candidate values as those of the data size and the carrying away position of the cryptography key data 83 to be currently carried away.

In this connection, it is applicable that the system is so constituted that, when the currently-found candidate values are different from those of all data sizes and all carrying away positions registered in the management table 55, the setting section 31 employs the currently-found candidate values concerned, or when the currently-found candidate values are different from those of several data sizes and several carrying away positions among all of them registered in the management table 55, the setting section 31 employs the currently-found candidate values concerned. For instance, it is also applicable that the system is so constituted that the setting section 31 employs the currently-found candidate values, unless the currently-found candidate values concerned are the same as those previously employed.

Successively, the cryptography key extracting section 32 of CPU 30 carries away the cryptography key data 83 from the carrying away position of the compressed image data 82 in accordance with the carrying away position and the data size, both established by the setting section 31 as abovementioned (Step S204C shown in FIG. 9, and P3d shown in FIG. 10).

The operations to be conducted in Step S205 and the following Steps, and Process P3d and the following Processes are the same as those indicated in the second embodiment. Accordingly, explanations for them will be omitted.

As described in the above, since the system is so constituted that both the data size and the carrying away position of the cryptography key data can be randomly changed in the third embodiment, compared to the case in which any one of the data size and the carrying away position is to be changed, it becomes possible to further heighten the encryption strength by heightening the complexity of the encryption processing. The other advantageous features and effects, which are the same as those achieved by the first and second embodiment, can be also acquired in the third embodiment as well.

Next, the fourth embodiment of the present invention will be detailed in the following. In this connection, the operations to be conducted in the fourth embodiment for processing the first page are the same as those of the first embodiment aforementioned.

In the fourth embodiment, the system is so constituted that the designation of the carrying away position, at which the cryptography key data is carried away from the compressed image data, is accepted from the user. For instance, an amount of offset from the leading top position, directly represented by numerical value or represented by a ratio of the offset versus a total amount of one page image data, is accepted from the user. Further, it is also applicable that an inputting screen is displayed on the display device so as to accept the designation of the carrying away position inputted by the user therefrom, and then, a position of the compressed image data, corresponding to the position inputted by the user, is calculated, so as to determine the calculated position as the carrying away position. According to the abovementioned, it becomes possible to achieve such a feature that, for instance, when the user designates a portion, at which important secret information appears, within the screen, the concerned portion is made to act as the cryptography key data.

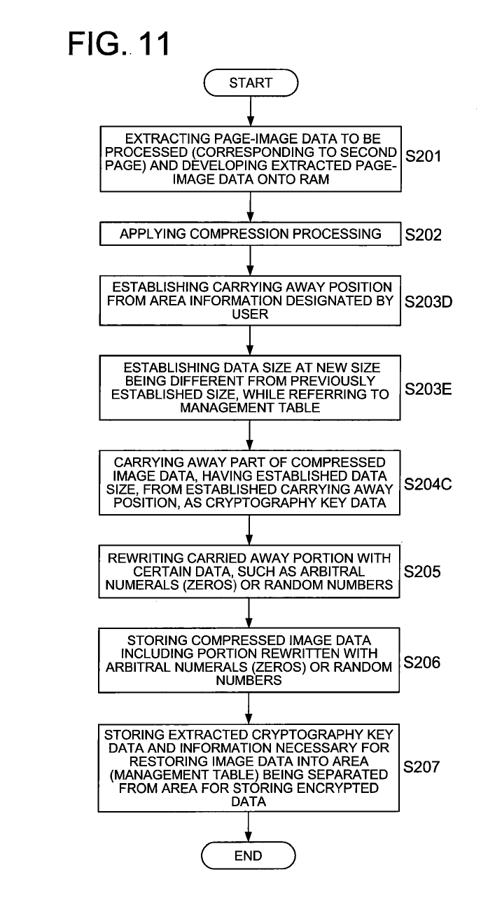

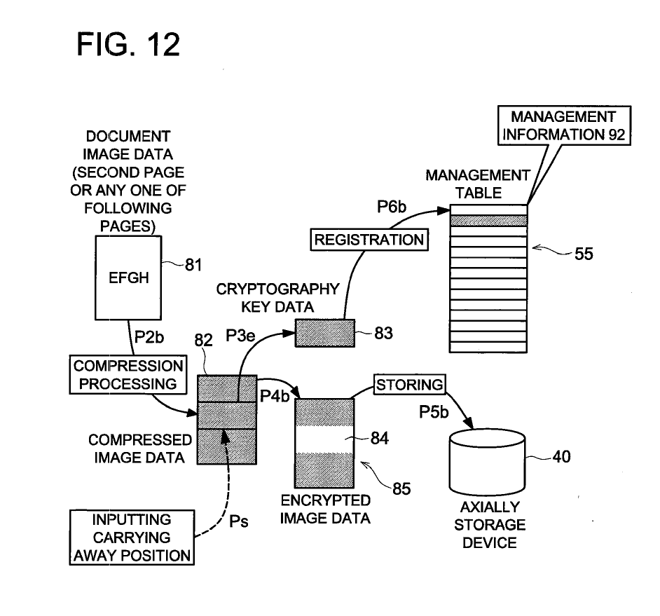

FIG. 11 shows a flowchart indicating a processing flow, which is to be implemented in the image forming apparatus 20, for compressing and encrypting page-image data representing a page-image residing within the second page or the later page of the processing objective document, and then, storing the processed page-image data, while, FIG. 12 shows a schematic diagram indicating transitions of the page-image data according to the processing flow in the flowchart shown in FIG. 11.

In this connection, the same step number is attached to the same steps indicated in the flowcharts respectively shown in FIG. 11 and FIG. 9. Further, the same process number is attached to the same processes indicated in the schematic diagrams respectively shown in FIG. 7 and FIG. 5.

Prior to the implementation of the main compression and the encryption, the CPU 30 accept the designation of the position of the area to be carried away as the cryptography key data, inputted by the user, through the display operating section 28.

After accepting the concerned designation inputted by the user, the CPU 30 extracts page-image data 81 to be employed as the processing object (page-image data corresponding to the second page or any one of the following pages, herein, defined as the page-image data corresponding to the second page), from image data 70, so as to develop the page-image data 81 onto the RAM 23 (Step S201 shown in FIG. 11). Successively, the CPU 30 makes the image processing section 29 compress the page-image data 81 developed in the RAM 23, so as to generate compressed image data 82, an then, stores the compressed image data 82 concerned into a storage area being separate from that for storing the page-image data 81 serving as the original page-image data (Step S202 shown in FIG. 11, and P2b shown in FIG. 12). Still successively, the setting section 31 of the CPU 30 establishes the position of the area to be carried away as the cryptography key data, according to the designation previously accepted from the user concerned (Step S203 shown in FIG. 11, and Ps shown in FIG. 12), and successively, also establishes the data size of the area to be carried away as the cryptography key data, at a size being different from that previously established (Step S203E shown in FIG. 11). Since the operation for setting the data size in Step S203E is the same as that in the flowchart shown in FIG. 5 as the first embodiment, its explanation is omitted herein.

Successively, the cryptography key extracting section 32 of CPU 30 carries away the cryptography key data 83 from the carrying away position established on the basis of the user's designation by the setting section 31 and in accordance with the data size established by the setting section 31 so as to avoid the duplication with the previously established data size (Step S204C shown in FIG. 11, and P3e shown in FIG. 12).

The operations to be conducted in Step S205 and the following Steps, and Process P4b and the following Processes are the same as those indicated in the second embodiment and the third embodiment. Accordingly, explanations for them will be omitted.

As described in the above, since the system is so constituted that the carrying away position is established on the basis of the user's designation, it becomes impossible for the injustice intruder to find out even a rule for setting the carrying away position. Accordingly, compared to such a conventional system in which the concerned apparatus automatically establishes the carrying away position in conformity with a predetermined setting rule, it becomes possible to heighten the strength of the cryptographic processing. Further, it becomes possible for the user to designate such a position from which the important secret information emerges, or its near front side position, as the carrying away position, resulting in further improvement of the security aspect of the secret information.

Further, since the data size is established at a value being different from the previous value (for instance, the last set value), with respect to this point, the same effect as that in the first embodiment can be obtained.

Next, the fifth embodiment of the present invention will be detailed in the following. In this connection, the operations to be conducted in the fifth embodiment for processing the first page are the same as those of the first embodiment aforementioned.

In the fifth embodiment, the system is so constituted that, with respect to the page-image data corresponding to the second page or any one of the following pages, two sets of the cryptography key data are carried away from the leading top position and a specific position other than the leading top position, respectively. In this connection, as well as the fourth embodiment, with respect to the specific position other than the leading top position, the system is so constituted that the designation of the specific position, serving as the carrying away position, at which the cryptography key data is carried away from the compressed image data, is accepted from the user.

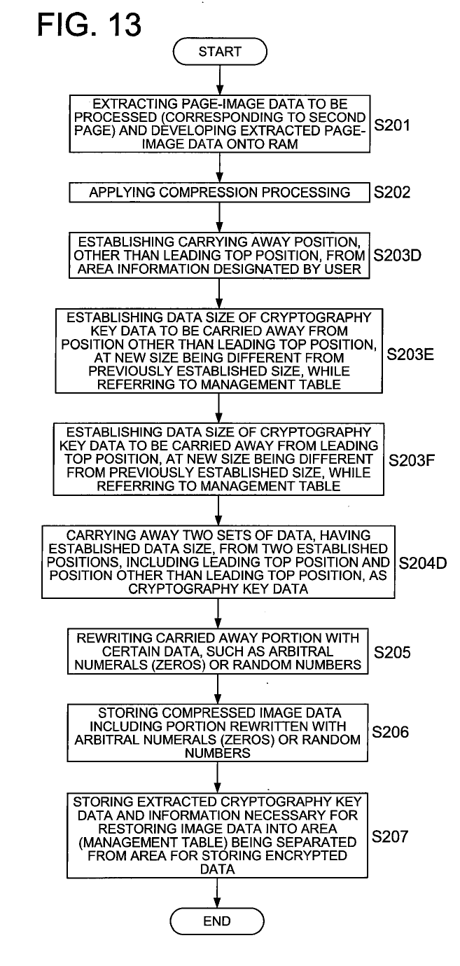

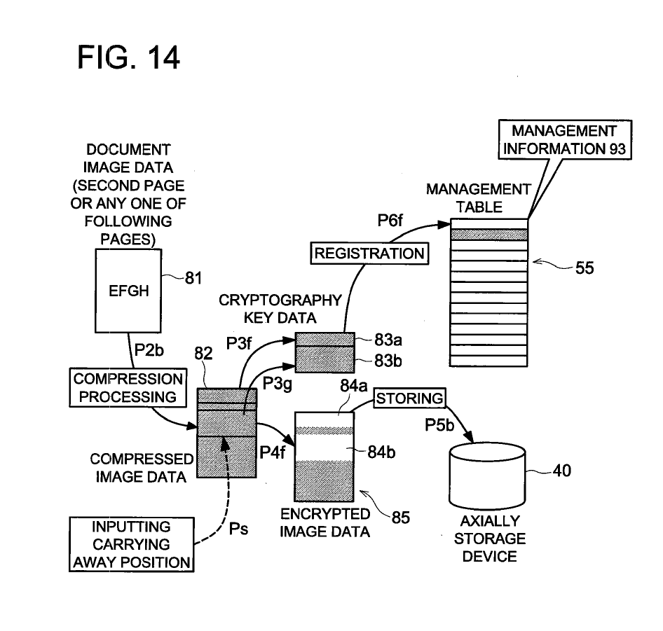

FIG. 13 shows a flowchart indicating a processing flow, which is to be implemented in the image forming apparatus 20, for compressing and encrypting page-image data representing a page-image residing within the second page or the later page of the processing objective document, and then, storing the processed page-image data, while, FIG. 14 shows a schematic diagram indicating transitions of the page-image data according to the processing flow in the flowchart shown in FIG. 13.

In this connection, the same step number is attached to the same steps indicated in the flowcharts respectively shown in FIG. 13 and FIG. 11. Further, the same process number is attached to the same processes indicated in the schematic diagrams respectively shown in FIG. 14 and FIG. 6.

Prior to the implementation of the main compression and encryption processing, the CPU 30 accept the designation of the specific position of the area to be carried away as the cryptography key data, inputted by the user, through the display operating section 28.

After accepting the concerned designation inputted by the user, the CPU 30 extracts page-image data 81 to be employed as the processing object (page-image data corresponding to the second page or any one of the following pages, herein, defined as the page-image data corresponding to the second page), from image data 70, so as to develop the page-image data 81 onto the RAM 23 (Step S201 shown in FIG. 13). Successively, the CPU 30 makes the image processing section 29 compress the page-image data 81 developed in the RAM 23, so as to generate compressed image data 82, an then, stores the compressed image data 82 concerned into a storage area being separate from that for storing the page-image data 81 serving as the original page-image data (Step S202 shown in FIG. 13, and P2b shown in FIG. 14). Still successively, the setting section 31 of the CPU 30 establishes the position of the area to be carried away as the cryptography key data, according to the designation previously accepted from the user concerned (Step S203D shown in FIG. 13, and Ps shown in FIG. 14), and successively, also establishes the data size of the area to be carried away as the cryptography key data, at a size being different from that previously established (Step S203E shown in FIG. 13). Since the operation for setting the data size in Step S203E is the same as that in the flowchart shown in FIG. 5 as the first embodiment, its explanation is omitted herein.

Still successively, the setting section 31 establishes the data size of the cryptography key data to be carried away from the leading top position, in a manner same as that in the first embodiment (Step S203F shown in FIG. 13).

The cryptography key extracting section 32 of the CPU 30 carries away two sets of the cryptography key data from the two positions, one of which is the specific position other than the leading top position established by the setting section 31 on the basis of the designation inputted by the user, and another one of which is the leading top position automatically established by the setting section 31 (Step S204D shown in FIG. 13). Concretely speaking, the cryptography key extracting section 32 extracts first cryptography key data 83a from the leading top position of the compressed image data 82 (P3f shown in FIG. 14), and further extracts second cryptography key data 83b from the specific position other than the leading top position (P3g shown in FIG. 14).

Still successively, the encrypting section 33 rewrites a first carried away portion 84a and a second carried away portion 84b, which are corresponds to the data areas carried away from the compressed image data 82 as the first cryptography key data 83a and the second cryptography key data 83b by the cryptography key extracting section 32, with certain data, such as zeros or arbitral numerals, random numbers or the like, having no correlation with the first cryptography key data 83a and the second cryptography key data 83b, both currently carried away (original data) (Step S205 shown in FIG. 13, and P4f shown in FIG. 14). Then, the CPU 30 creates a file for the above-rewritten compressed image data as the file of encrypted image data 85, so as to store it into the axially storage device 40 (Step S206 shown in FIG. 13, and P5b shown in FIG. 14).

Yet successively, the CPU 30 combines the two sets of cryptography key data, which are respectively carried away from the leading top position and the specific position other than the leading top position, into a single series of cryptography key data. Then, the CPU 30 generates management information 93 in which the file name of the encrypted image data 85, the above-combined single series of cryptography key data, cryptography key data 83, and the size information and the address information in regard to each of the first cryptography key data 83a and the second cryptography key data 83b, both carried away form the page-image data 81, are correlated with each other, and additionally registers the management information 92, above-generated, into the management table 55 (Step S207 shown in FIG. 13, and P6f shown in FIG. 14) to finalize the current processing (END).

As described in the above, since the system is so constituted that the two sets of cryptography key data are respectively carried away from two different positions, one of which is the leading top position and another one of which is the specific position other than the leading top position, and the both carried away portions of the compressed image data are rewritten with certain data being different from the original data, even if the cryptographic bather of the leading top portion of the compressed image data is cracked by the injustice intruder, it becomes possible to maintain the security of the compressed image data concerned as a whole, due to the existence of the specific portion other than the leading top portion. In addition to the above, the effects of the first embodiment and the fourth embodiment can be also obtained in the fifth embodiment as well.

Next, the sixth embodiment of the present invention will be detailed in the following. In this connection, the operations to be conducted in the sixth embodiment for processing the first page are the same as those of the first embodiment aforementioned.

In the sixth embodiment, the system is so constituted that, with respect to the page-image data corresponding to the second page or any one of the following pages, two sets of the cryptography key data are carried away from the leading top position and a specific position other than the leading top position, respectively, and both the data sizes and the carrying away positions of the two sets of the cryptography key data are automatically established by the apparatus side without accepting the designation of the specific position, serving as the carrying away position, from the user.

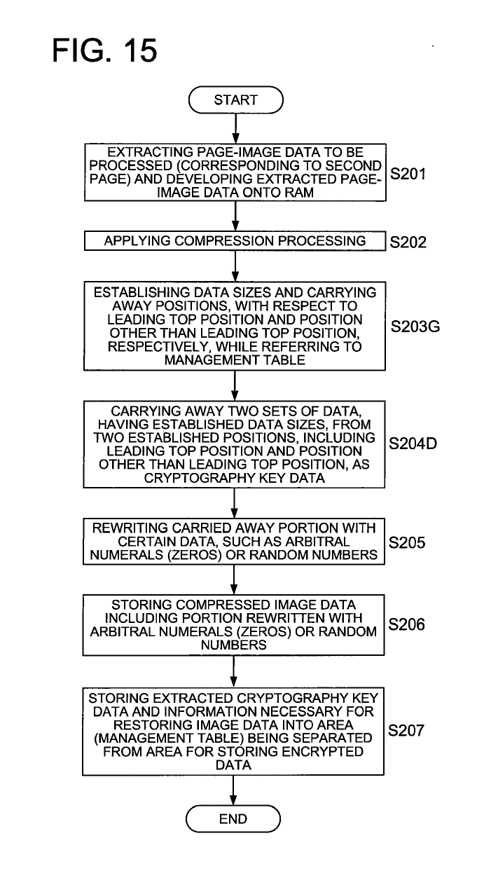

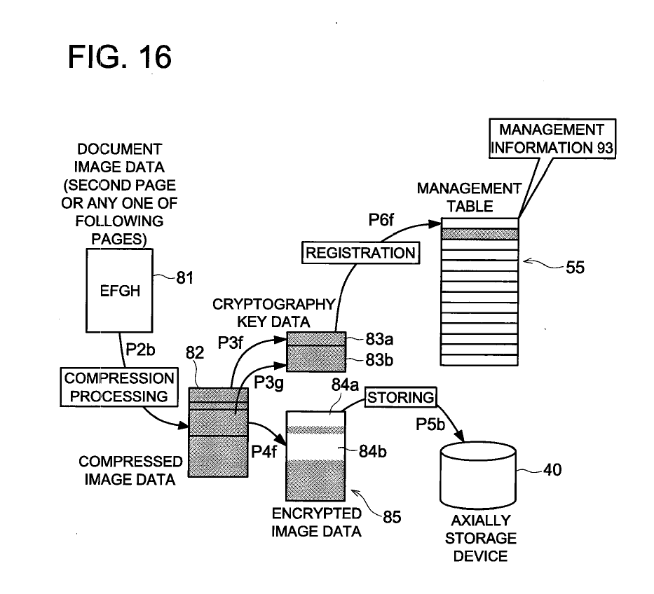

FIG. 15 shows a flowchart indicating a processing flow, which is to be implemented in the image forming apparatus 20, for compressing and encrypting page-image data representing a page-image residing within the second page or the later page of the processing objective document, and then, storing the processed page-image data, while, FIG. 16 shows a schematic diagram indicating transitions of the page-image data according to the processing flow in the flowchart shown in FIG. 15.

In this connection, the same step number is attached to the same steps indicated in the flowcharts respectively shown in FIG. 5, FIG. 13 and FIG. 11. Further, the same process number is attached to the same processes indicated in the schematic diagrams respectively shown in FIG. 14 and FIG. 16.

After accepting the concerned designation inputted by the user, the CPU 30 extracts page-image data 81 to be employed as the processing object (page-image data corresponding to the second page or any one of the following pages, herein, defined as the page-image data corresponding to the second page), from image data 70, so as to develop the page-image data 81 onto the RAM 23 (Step S201 shown in FIG. 15). Successively, the CPU 30 makes the image processing section 29 compress the page-image data 81 developed in the RAM 23, so as to generate compressed image data 82, an then, stores the compressed image data 82 concerned into a storage area being separate from that for storing the page-image data 81 serving as the original page-image data (Step S202 shown in FIG. 15, and P2b shown in FIG. 16). Still successively, the setting section 31 of the CPU 30 establishes the data size of the cryptography key data to be carried away from the leading top position of the compressed image data 82, and also establishes the other data size and the carrying away position of the other cryptography key data to be carried away from the specific position other than the leading top position, at values being different from those previously established, respectively (Step S203G shown in FIG. 15). Since the operation for setting the data size of the cryptography key data to be carried away from the leading top position is the same as that in the flowchart shown in FIG. 5 as the first embodiment, and the operations for setting the other data size and the carrying away position of the other cryptography key data to be carried away from the specific position other than the leading top position are the same as those in the flowchart shown in FIG. 9 as the third embodiment, the explanations for them are omitted herein.

The cryptography key extracting section 32 of the CPU 30 carries away two sets of the cryptography key data from the two different positions, one of which is the leading top position established by the setting section 31, and another one of which is the specific position other than the leading top position established by the setting section 31 as abovementioned (Step S204D shown in FIG. 15). Concretely speaking, the cryptography key extracting section 32 extracts the first cryptography key data 83a from the leading top position of the compressed image data 82 (P3f shown in FIG. 16), and further extracts the second cryptography key data 83b from the specific position other than the leading top position (P3g shown in FIG. 16).

Since the operations to be conducted in Step S205, P4f and the following steps are the same as those indicated in the flowchart shown in FIG. 13 and FIG. 14 as the fifth embodiment, the explanations for them are omitted herein.

As described in the above, the sixth embodiment is different from the fifth embodiment on the point that the carrying away position and the data size are automatically established in the apparatus side. According to the sixth embodiment, it becomes possible to omit the user's operation for designating the carrying away position of the cryptography key data, and accordingly, it becomes possible to increase the cryptographic strength of the compressed image data concerned without requesting the operational burden of the user. In addition to the above, the effects of the fifth embodiment can be also obtained in the sixth embodiment as well.

Next, the seventh embodiment of the present invention will be detailed in the following.

In each of the first through the sixth embodiments, the portion of the compressed image data, from which the cryptography key data is carried away, is destroyed by replacing the original data with other data having a value different from that of the original data. However, in the seventh embodiment, the system is so constituted that the portion of the compressed image data, from which the cryptography key data is carried away, is deleted from the compressed image data concerned. Other than the above, the methods for establishing the data size and the carrying away position of the cryptography key data, the operations for storing the management information and the cryptography key data, etc., are the same as those in the first through the sixth embodiments.

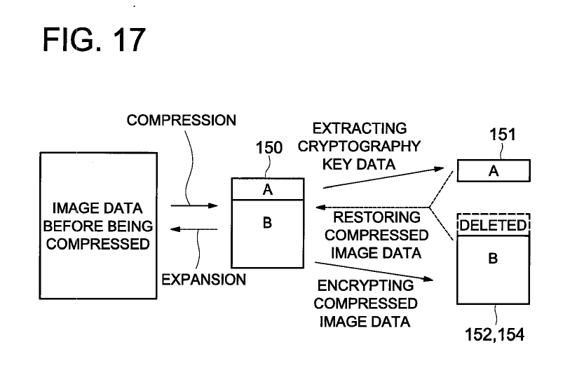

FIG. 17 shows a schematic diagram indicating a principle of the cryptographic processing to be conducted in the seventh embodiment. The bold arrows and the broken arrows, both shown in FIG. 17, indicate a data processing flow when applying the compression and encryption processing, and another data processing flow when applying the decryption and expansion processing, respectively.

As shown in FIG. 17, compressed image data 150, created by compressing the original image data, is divided into cryptography key data 151 and residual compressed image data 152, defined as a remaining portion of the compressed image data 150 after the cryptography key data 151 is carried away therefrom. Accordingly, the residual compressed image data 152 serves as the encrypted data. To restore the original image data, the cryptography key data 151 and the residual compressed image data 152 are combined with each other.

In this connection, when the portions to be deleted as the cryptography key data are carried away from two positions or more in the compressed image data 150 (the leading top position and the position(s) other than the leading top position), it is preferable that the system is so constituted that the plural sets of residual compressed image data 152, serving as the divided encrypted data, are combined into a single set of encrypted data to be stored it as the single set of residual compressed image data 152. In this case, the connecting position(s) can be derived from the data size and the carrying away positions included in the management information.

As abovementioned, according to the seventh embodiment, since the portions carried away as the cryptography key data are deleted, it becomes possible to reduce the data size of encrypted image data 154, so as to make the memory capacity necessary for storing the concerned data reduce.

Next, the processing for restoring the original image data from the encrypted data, encrypted in each of the first through the seventh embodiments, will be detailed in the following.

Receiving an input of the file name of the encrypted data, serving as the decrypting objective, the compression data restoring section 34 retrieves the management table 55 by using the file name inputted, so as to extract the management information including the file name concerned. Successively, the compression data restoring section 34 reads out the encrypted data corresponding to the file name inputted (equivalent to connection information) from the axially storage device 40.

Still successively, from the above-extracted management information, the compression data restoring section 34 acquires the encryption history information (including size information, representing the data size, and address information representing the carrying away position) in regard to the cryptography key data concerned. In this connection, when the encryption history information includes plural sets of size information and plural sets of address information, plural sets of cryptography key data have been carried away from plural positions. To cope with the abovementioned, when the encryption history information includes plural sets of size information and plural sets of address information, the compression data restoring section 34 divides the cryptography key data included in the management information according to the information concerned.

Concretely speaking, the compression data restoring section 34 sequentially conducts the following processing in order of the plurality carrying away positions included in the encryption history information, the carrying away position being nearest to the leading top position first. The processing includes: acquiring the data size corresponding to the carrying away position in the current pair of them; carrying away data, corresponding to the data size concerned, from the leading top position of the cryptography key data (at the second time or later, from the leading top position of its residual portion); and making the carrying away portion at the leading top position side, to be the cryptography key data corresponding to the carrying away position concerned.

Still successively, the compression data restoring section 34 overwrites the cryptography key data concerned onto the area located at the concerned position of the encrypted data according to the carrying away position (address information) and the data size (size information) included in the encryption history information. As a result of the above process, the original compressed image data is restored. In this connection, when the carrying away portions of the cryptography key data are deleted, the compression data restoring section 34 sequentially inserts the cryptography key data corresponding to the encrypted image data, at the position indicated by the carrying away position concerned (address information), in order of the plurality carrying away positions included in the encryption history information, the carrying away position being nearest to the leading top position first.

Referring to the drawings, the embodiments of the present invention have been described in the foregoing. However, the scope of the present invention is not limited to the aforementioned embodiments. Modifications and additions, made by a skilled person without departing from the spirit and scope of the invention, shall be included in the scope of the present invention.

For instance, although the compression processing have been applied to the image data in a unit of every page in the embodiments of the present invention, the unit of the compression processing is not limited to a single page, but it is also applicable that the compression processing is applied to the image data in a unit of plural pages. Still further, it is applicable that the unit of the encryption processing is set at an arbitral size having no relation with the page delimitations.

Still further, although the cryptography key data is carried away from the leading top position when the compressed image data of the first page is to be encrypted in the embodiments of the present invention, it is also applicable that the system is so constituted that the cryptography key data is carried away from a certain position other than the leading top position. For instance, it is applicable that the certain position, serving as the carrying away position, is determined by employing the random numerals or the like.

The data size of the cryptography key data is established at a value being smaller than that of the compressed image data remaining below the carrying away position. In addition to this condition, the data size is preferably established at such a value that is equal to or smaller than the maximum size, such as a half size of the compressed image data, a size smaller than its quarter size, etc., and equal to or greater than the minimum value, such as a size of 10 bites, etc. Further, with respect to the carrying away position, its setting value is established in such a manner that the position, determined by adding the data size to the carrying away position concerned, does not exceeds the trailing edge position of the compressed image data. Still further, when two or more carrying away portions exist, the data sizes and the carrying away positions of them are established in such a manner that the carrying away portions concerned neither continue one after another nor overlap with each other. When it is determined that the abovementioned conditions cannot be fulfilled, the operations for reselecting the candidate values of the data size(s) and the carrying away position(s) in regard to the carrying away portion(s) will be conducted.

It is applicable that the user's designations in regard to the carrying away position and/or the data size of the cryptography key data are accepted every time when the compression/encryption processing of the image data are implemented. Alternatively, it is also applicable that the system is so constituted that the values of them are registered in advance for every user, so as to use the registered values for the compression/encryption processing of the image data of the corresponding user.

Further, although the fourth and the fifth embodiments are so constituted that the user's designation with respect to the carrying away position of the cryptography key data is accepted, it is also applicable that the user's designation with respect to the data size of the cryptography key data is accepted. Still further, in the system in which the plural sets of the cryptography key data are carried away from the leading top position and the plural positions other than the leading top position, it is also applicable that the system is so constituted that the user's designation in regard to the data size of the cryptography key data is accepted.

It is recommended that the management information be deleted from the management table at the time when the encrypted data, corresponding to the management information concerned, has been decrypted. Further, it is also applicable that the system is so constituted that, among the management information, the size information representing the data size and the address information representing the carrying away position are still stored as the encryption history information, even after the corresponding encrypted data has been decrypted, so that the setting section 31 can refer them to determine the data size, etc. According to the above, it becomes possible to avoid the duplication of the data sizes, etc., for a term longer than ever, resulting in further improvement of the security aspects of the system. In this connection, it is still applicable that the upper limit of the term for storing the information as the encryption history information, and the other upper limit of the number of the information to be maintained in the storage are determined in advance, so that, every time when overriding any one of the upper limits, the concerned one among the stored information is deleted in order of the stored times, the oldest one first. According to the above, since the changeable range of the data size or the like is finite, by limiting the storage capacity of the encryption history information, it becomes possible to prevent such cases that the value being different from the previous value becomes un-selectable and the selectable range becomes extremely narrowed.

Further, with respect to the data size and the carrying away position of the cryptography key data in the encryption processing of the first page, although the processing for avoiding the duplication with previous value is not conducted in each of the aforementioned embodiments of present invention, it is also applicable that the system is so constituted that the value, being same as that previously established, should be avoided. For instance, it is preferable that the duplications with the data size an the carrying away position, which were employed in the encryption processing conducted in the past, are avoided by referring to the management table 55.

Still further, when the plural sets of the cryptography key data are carried away from the leading top position and the certain position other than the leading top position, although the certain position other than the leading top position is a single position in the aforementioned embodiment of the present invention, it is also applicable that more than two plural sets of the cryptography key data are carried away from the leading top position and plural positions other than the leading top position. Still further, when the plural sets of the cryptography key data are carried away from the leading top position and the single or plural position(s) other than the leading top position, it is merely necessary for the setting section 31 to conduct the operation for changing data size and the carrying away position in respect to at least any one of the single or plural position(s) without conducting the operations in respect to all of them. Still further, it is needless to say that the change of the carrying away position, established by the setting section 31, is only applied to the carrying away position other than the leading top position.

Still further, it is also applicable that the cryptography key data is stored in an external storage device located outside the image forming apparatus concerned. For instance, the detachable storage medium, such as a USB (Universal Serial Bus) storage, etc., an external terminal device provided with a storage device, etc., can be employed for this purpose.

Still further, it is applicable that another security function (for instance, a password authenticating function) is added to the system, when the encrypted data is decrypted.

Still further, although the management information including the cryptography key data is stored in the nonvolatile storage device, while the encrypted data is stored in the axially storage device, in each of the aforementioned embodiments of the present invention, it is also applicable that the management information and the encrypted data are respectively stored into the separated areas provided in the same storage device. In this connection, by respectively storing the cryptography key data and the encrypted data into the physically separated storage mediums, even in case that an injustice intruder has stolen the any one of the separated storage mediums and succeeded in analyzing the contents of the data stored therein, it is impossible for the injustice intruder to restore the encrypted data due to the lack of another one of the separated storage mediums. As a result, it becomes possible to maintain a high security performance of the encrypted data concerned.

Still further, it is applicable that the management information, the encryption history information, etc., which are to be used as the restoring information, are encrypted and stored, separately. Still further, it is applicable that the system is so constituted that the user can browse the file names registered in the management table. Still further, it is also applicable that a security wall, such as a password authentication, etc., for browsing the file names is established.

Yet further, although the Digital MFP (Multi Function Peripheral) has been employed as an example of the image forming apparatus 20 embodied in the present invention, it is needless to say that the present invention is also applicable for any kinds of image forming apparatuses, for instance, a copier, a facsimile apparatus, etc.

According to any one of the data concealing apparatus and the image forming apparatus, embodied in the present invention, since the cryptography key data is created by carrying away a portion of the compressed data from the compressed data that is acquired by applying a compression processing to the original image data wherein the compression processing employs such a data compressing method that makes it impossible to restore the original image data by applying the expansion processing to the compressed data when even a fraction of the compressed data is incorrect, and then, the compressed data is encrypted by destroying the portion of the compressed data, which has been carried away as the cryptography key data, it becomes possible not only to encrypt the compressed data through a simple process, but also to conceal the concerned data without adding a special hardware and/or without burdening the CPU with a large amount of load, resulting in improvement of the security aspect of the apparatus concerned. Further, since it is also possible to change the data size and/or the carrying away position of the portion to be carried away as the cryptography key data, even if an injustice intruder has broken the security wall of certain encrypted data, it becomes possible to safely secure the other security wall of other encrypted data.

According to the data restoring apparatus embodied in the present invention, it becomes possible to appropriately decrypt the encrypted compression data encrypted by the data concealing apparatus above-mentioned.

While the preferred embodiments of the present invention have been described using specific term, such description is for illustrative purpose only, and it is to be understood that changes and variations may be made without departing from the spirit and scope of the appended claims.

What is claimed is:

1. A data concealing apparatus, comprising:
an establishing section to establish a data size of a portion of compressed data in a changeable manner, wherein the compressed data is acquired by applying a compression processing to original image data, and the compression processing employs such a data compressing method that makes it impossible to restore the original image data by applying an expansion processing to the compressed data when even a fraction of the compressed data is incorrect, and the portion of compressed data is to be carried away from the compressed data as cryptography key data;
a cryptography key extracting section to extract the portion of compressed data from the compressed data as the cryptography key data, while making a data size of the cryptography key data coincide with the data size established by the establishing section; and
an encrypting section to encrypt the compressed data by replacing the portion of compressed data, extracted as the cryptography key data by the cryptography key extracting section, with certain data being different from the cryptography key data.

2. The data concealing apparatus of claim 1,
wherein the establishing section also establishes a carrying away position, from which the portion of compressed data is carried away from the compressed data as the cryptography key data, in a changeable manner; and
wherein the cryptography key extracting section extracts the cryptography key data from the carrying away position established by the establishing section, while making the data size of the cryptography key data coincide with the data size established by the establishing section.

3. The data concealing apparatus of claim 1,
wherein the cryptography key extracting section creates plural sets of cryptography key data by extracting plural portions of the compressed data from plural carrying away positions of the compressed data, including a leading top position, and a single position or plural positions, both other than the leading top position; and
wherein, with respect to at least one of the plural carrying away positions, the establishing section establishes the data size.

4. The data concealing apparatus of claim 1,
wherein the establishing section accepts an inputted setting content, and establishes a setting content of the cryptography key data to be extracted by the cryptography key extracting section, based on the inputted setting content accepted in advance.

5. The data concealing apparatus of claim 1,
wherein the establishing section stores the data size as encryption history information, therein, so as to determine the data size while referring to the encryption history information

6. The data concealing apparatus of claim 1,
wherein the encrypting section encrypts the compressed data by deleting the portion of compressed data, extracted as the cryptography key data, instead of by replacing the portion of compressed data with the certain data being different from the cryptography key data.

7. The data concealing apparatus of claim 1,
wherein the establishing section establishes the data size at one of randomly changed values.

8. A data concealing apparatus, comprising:
an establishing section to establish a carrying away position of compressed data in a changeable manner, wherein the compressed data is acquired by applying a compression processing to original image data, and the compression processing employs such a data compressing method that makes it impossible to restore the original image data by applying an expansion processing to the compressed data when even a fraction of the compressed data is incorrect, and a portion of compressed data is to be carried away from the carrying away position as cryptography key data;
a cryptography key extracting section to extract the portion of compressed data from the carrying away position of the compressed data as the cryptography key data; and
an encrypting section to encrypt the compressed data by replacing the portion of compressed data, extracted as the cryptography key data by the cryptography key extracting section, with certain data being different from the cryptography key data.

9. The data concealing apparatus of claim 8,
wherein the cryptography key extracting section creates plural sets of cryptography key data by extracting plural portions of the compressed data from plural carrying away positions of the compressed data, including a leading top position, and a single position or plural positions, both other than the leading top position; and
wherein, with respect to at least one of the plural carrying away positions, the establishing section establishes the carrying away position.

10. The data concealing apparatus of claim 8,
wherein the establishing section accepts an inputted setting content, and establishes a setting content of the cryptography key data to be extracted by the cryptography key extracting section, based on the inputted setting content accepted in advance.

11. The data concealing apparatus of claim 8,
wherein the establishing section stores the carrying away position as encryption history information, therein, so as to determine the carrying away position while referring to the encryption history information

12. The data concealing apparatus of claim 8,
wherein the encrypting section encrypts the compressed data by deleting the portion of compressed data, extracted as the cryptography key data, instead of by replacing the portion of compressed data with the certain data being different from the cryptography key data.

13. The data concealing apparatus of claim 8,
wherein the establishing section establishes the carrying away position at one of randomly changed positions.

14. A data restoring apparatus, comprising:
an information acquiring section to acquire information representing a data size of cryptography key data extracted from compressed data by a cryptography key extracting section provided in a data concealing apparatus that comprises: an establishing section to establish a data size of a portion of the compressed data in a changeable manner wherein the compressed data is acquired by applying a compression processing to original image data, and the compression processing employs such a data compressing method that makes it impossible to restore the original image data by applying an expansion processing to the compressed data when even a fraction of the compressed data is incorrect, and the portion of compressed data is to be carried away from the compressed data as the cryptography key data; the cryptography key extracting section to extract the portion of compressed data from the compressed data as the cryptography key data, while making a data size of the cryptography key data coincide with the data size established by the establishing section; and an encrypting section to encrypt the compressed data by replacing the portion of compressed data, extracted as the cryptography key data by the cryptography key extracting section, with certain data being different from the cryptography key data, so as to generate encrypted compression data; and
a compressed data restoring section to restore the encrypted compression data to the compressed data by combining the cryptography key data, extracted from the compressed data by the data concealing apparatus, with the encrypted compression data, based on the information acquired by the information acquiring section.

15. A data restoring apparatus, comprising:
an information acquiring section to acquire information representing a carrying away position, from which cryptography key data is to be extracted from compressed data by a cryptography key extracting section provided in a data concealing apparatus that comprises: an establishing section to establish the carrying away position of the compressed data in a changeable manner, wherein the compressed data is acquired by applying a compression processing to original image data, and the compression processing employs such a data compressing method that makes it impossible to restore the original image data by applying an expansion processing to the compressed data when even a fraction of the compressed data is incorrect, and a portion of compressed data is to be carried away from the carrying away position as the cryptography key data; the cryptography key extracting section to extract the portion of compressed data from the carrying away position as the cryptography key data; and an encrypting section to encrypt the compressed data by replacing the portion of compressed data, extracted as the cryptography key data by the cryptography key extracting section, with certain data being different from the cryptography key data, so as to generate encrypted compression data; and
a compressed data restoring section to restore the encrypted compression data to the compressed data by combining the cryptography key data, extracted from the compressed data by the data concealing apparatus, with the encrypted compression data, based on the information acquired by the information acquiring section.

16. An image forming apparatus, comprising:
a reading section that reads a document to acquire image data representing an image of the document;
a compression processing section that applies compression processing to the image data to generate compressed data, wherein the compression processing employs such a data compressing method that makes it impossible to restore the original image data by applying an expansion processing to the compressed data when even a fraction of the compressed data is incorrect;
a data concealing unit that comprises an establishing section to establish a data size of a portion of compressed data in a changeable manner wherein the portion of compressed data is to be carried away from the compressed data as cryptography key data, a cryptography key extracting section to extract the portion of compressed data from the compressed data as the cryptography key data while making a data size of the cryptography key data coincide with the data size established by the establishing section, and an encrypting section to encrypt the compressed data by replacing the portion of compressed data, extracted as the cryptography key data by the cryptography key extracting section, with certain data being different from the cryptography key data, so as to generate encrypted compression data;
a cryptography key storing section to store the cryptography key data extracted from the compressed data by the cryptography key extracting section provided in the data concealing unit, therein;
an encrypted compression data storing section to store the encrypted compression data generated by the encrypting section provided in the data concealing unit, therein;
a coupling information storing section to store coupling information representing a correlation between the cryptography key data and the encrypted compression data, therein;
a carrying-away area storing section to store the data size of the cryptography key data, therein, while correlating the data size with the encrypted compression data generated from the compressed data;
a data restoring unit that acquires the cryptography key data from the cryptography key storing section, the encrypted compression data from the encrypted compression data storing section and the data size from the carrying-away area storing section, to combine the cryptography key data and the encrypted compression data with each other based on the cryptography key data, the encrypted compression data and the data size so as to restore the encrypted compression data to the compressed data originally generated by the compression processing section;
an expansion processing section to apply an expansion processing to the compressed data restored by the data restoring unit, so as to restore the compressed data to the image data originally acquired by the reading section; and
a printing section to form the image, represented by the image data restored by the expansion processing section, onto a recording paper sheet, and then, to output the recording paper sheet on which the image is formed.

17. An image forming apparatus, comprising:
a reading section that reads a document to acquire image data representing an image of the document;
a compression processing section that applies compression processing to the image data to generate compressed data, wherein the compression processing employs such a data compressing method that makes it impossible to restore the original image data by applying an expansion processing to the compressed data when even a fraction of the compressed data is incorrect;
a data concealing unit that comprises an establishing section to establish a carrying away position of compressed data in a changeable manner wherein a portion of compressed data is to be carried away from the carrying away position as cryptography key data, a cryptography key extracting section to extract the portion of compressed data from the carrying away position of the compressed data as the cryptography key data, and an encrypting section to encrypt the compressed data by replacing the portion of compressed data, extracted as the cryptography key data by the cryptography key extracting section, with certain data being different from the cryptography key data, so as to generate encrypted compression data;
a cryptography key storing section to store the cryptography key data extracted from the compressed data by the cryptography key extracting section provided in the data concealing unit, therein;
an encrypted compression data storing section to store the encrypted compression data generated by the encrypting section provided in the data concealing unit, therein;
a coupling information storing section to store coupling information representing a correlation between the cryptography key data and the encrypted compression data, therein;
a carrying-away area storing section to store the carrying away position of the cryptography key data, therein, while correlating the carrying away position with the encrypted compression data generated from the compressed data;
a data restoring unit that acquires the cryptography key data from the cryptography key storing section, the encrypted compression data from the encrypted compression data storing section and the carrying away position from the carrying-away area storing section, to combine the cryptography key data and the encrypted compression data with each other based on the cryptography key data, the encrypted compression data and the carrying away position so as to restore the encrypted compression data to the compressed data originally generated by the compression processing section;
an expansion processing section to apply an expansion processing to the compressed data restored by the data restoring unit, so as to restore the compressed data to the image data originally acquired by the reading section; and
a printing section to form the image, represented by the image data restored by the expansion processing section, onto a recording paper sheet, and then, to output the recording paper sheet on which the image is formed.
